(19) United States
(12) Patent Application Publication
(10) Pub. No.: US 2011/0225769 A1
(43) Pub. Date: Sep. 22, 2011

(54) Castor Assembly for a Chair

(76) Inventor: Po-Chuan Tsai, Rende Hsiang (TW)

(21) Appl. No.: 12/728,409

(22) Filed: Mar. 22, 2010

(51) Int. Cl. B60B 33/00

(52) U.S. Cl. 16/31 A

(57) ABSTRACT

A castor assembly includes an upright support shaft, a leg mounted on the support shaft and a pressing sleeve mounted between the upper end of the support shaft and the leg. The upper end of the support shaft has a retaining groove. The pressing sleeve has an inner wall provided with an inner flange retained in the retaining groove of the support shaft and an outer wall provided with an outer flange. The leg has an end portion provided with a receiving space pressing the outer flange of the pressing sleeve. Thus, the support shaft is combined with the leg by the pressing sleeve to prevent from defining a gap between the support shaft and the leg so that the support shaft will not hit the leg so as to prevent from producing noise or vibration.

### BACKGROUND OF THE INVENTION

1. Field of the Invention

The present invention relates to a castor and, more particularly, to a castor assembly for a chair.

2. Description of the Related Art

A conventional castor assembly for a chair in accordance with the prior art shown in FIGS. 6 and 7 comprises a leg 4, an upright support shaft 1 having an upper end mounted on the leg 4 by a C-shaped snap ring 2, and a castor 3 mounted on the lower end of the support shaft 1. The leg 4 has an end portion provided with a receiving space 41 mounted on the upper end of the support shaft 1. The upper end of the support shaft 1 has a periphery provided with an annular retaining groove 11 to receive the C-shaped snap ring 2. The C-shaped snap ring 2 is pressed between the upper end of the support shaft 1 and a peripheral wall of the receiving space 41 of the leg 4 to lock the leg 4 onto the support shaft 1.

However, the C-shaped snap ring 2 is fitted into the retaining groove 11 of the support shaft 1 loosely so that a gap 12 is defined between the C-shaped snap ring 2 and the retaining groove 11 of the support shaft 1. Thus, when the castor 3 is rolling, the C-shaped snap ring 2 easily vibrates or sways in the retaining groove 11 of the support shaft 1 and will hit the wall of the retaining groove 11 of the support shaft 1 and the wall of the receiving space 41 of the leg 4 to produce noise during rolling of the castor 3. In addition, both of the C-shaped snap ring 2 and the leg 4 are made of metallic material so that the C-shaped snap ring 2 and the leg 4 are easily worn due to a frequent rubbing action during a long-term utilization. Thus, the gap between the C-shaped snap ring 2 and the leg 4 is enlarged to increase the noise.

### BRIEF SUMMARY OF THE INVENTION

In accordance with the present invention, there is provided a castor assembly, comprising an upright support shaft and a pressing sleeve mounted on an upper end of the support shaft. The upper end of the support shaft has a periphery provided with an annular retaining groove. The pressing sleeve has an inner wall provided with an inner flange retained in the retaining groove of the support shaft and an outer wall provided with an outer flange.

The castor assembly further comprises a leg mounted on the support shaft and the pressing sleeve. The leg has an end portion provided with a receiving space mounted on the support shaft and pressing the pressing sleeve. The receiving space of the leg has a peripheral wall pressing the outer flange of the pressing sleeve.

The primary objective of the present invention is to provide a castor assembly that will not produce noise during rotation and has a smaller friction.

According to the primary objective of the present invention, the support shaft is combined with the leg closely and completely by provision of the pressing sleeve between the support shaft and the leg to prevent from defining a gap between the support shaft and the leg so that the support shaft will not hit the leg so as to prevent from producing noise or vibration during movement of the castor.

According to another objective of the present invention, the pressing sleeve is made of a resilient plastic material so that the support shaft is combined with the leg closely and tightly.

According to a further objective of the present invention, the pressing sleeve is made of a resilient plastic material to reduce the friction between the pressing sleeve and the leg so that the pressing sleeve and the leg will not produce a gap due to a long-term rubbing action so as to prevent from producing noise and to enhance the lifetime of the castor assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a castor assembly for a chair in accordance with the preferred embodiment of the present invention.

FIG. 2 is an exploded perspective view of the castor assembly for a chair as shown in FIG. 1.

FIG. 3 is a front cross-sectional view of the castor assembly for a chair as shown in FIG. 1.

FIG. 4 is a front cross-sectional view of the castor assembly for a chair in accordance with the preferred embodiment of the present invention.

FIG. 5 is a partially enlarged view of the castor assembly for a chair taken along circle “A” as shown in FIG. 1.

FIG. 6 is a partially exploded perspective view of a conventional castor assembly for a chair in accordance with the prior art.

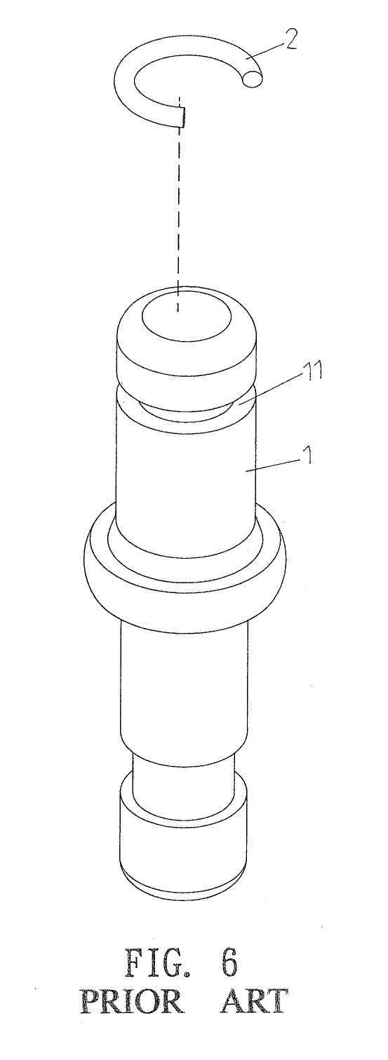

FIG. 7 is a front cross-sectional assembly view of the conventional castor assembly for a chair in accordance with the prior art.

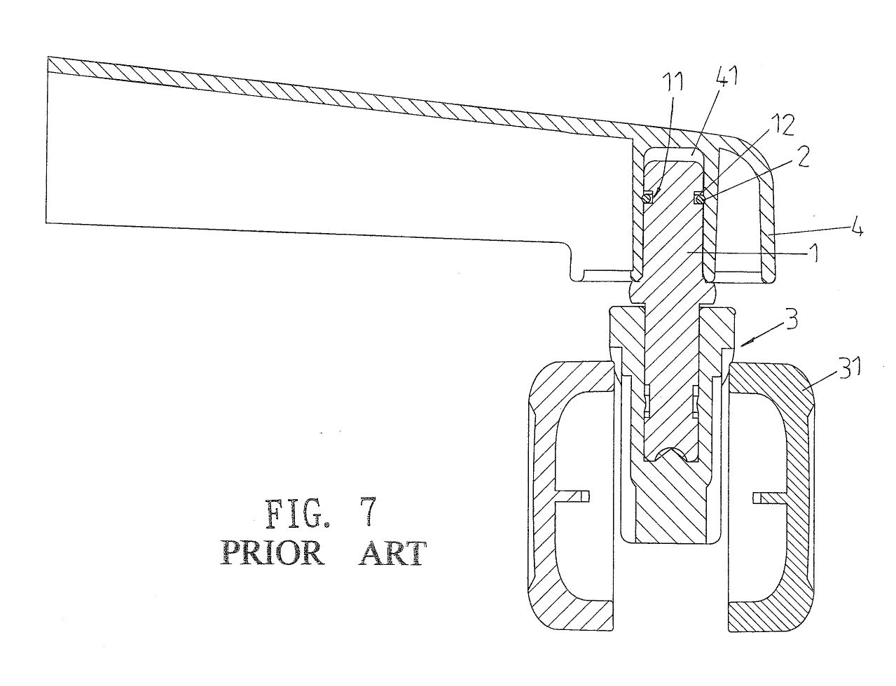

### DETAILED DESCRIPTION OF THE INVENTION

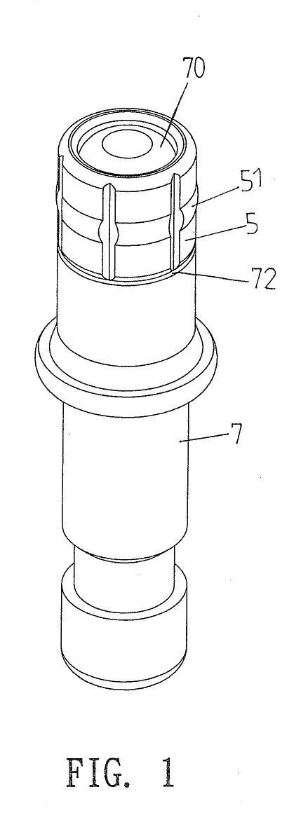

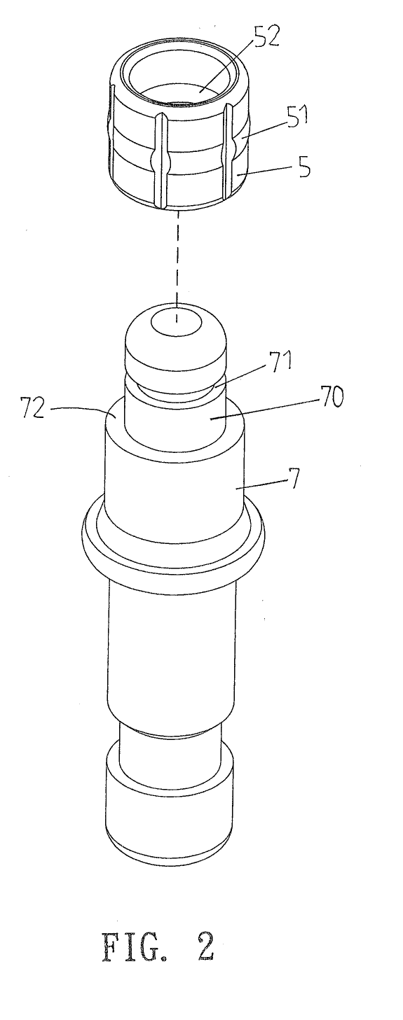

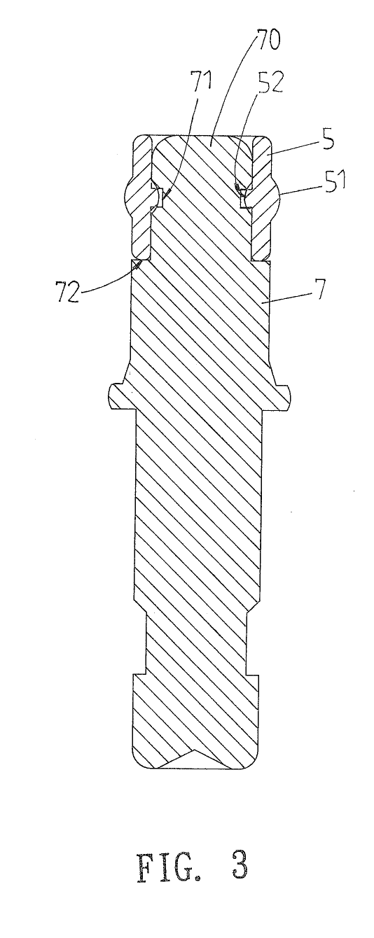

Referring to the drawings and initially to FIGS. 1-3, a castor assembly for a chair in accordance with the preferred embodiment of the present invention comprises an upright support shaft 7 and a pressing sleeve 5 mounted on an upper end 70 of the support shaft 7.

The upper end 70 of the support shaft 7 has a periphery provided with an annular retaining groove 71. The upper end 70 of the support shaft 7 has a size smaller than that of the support shaft 7. The support shaft 7 has a surface provided with a stop shoulder 72 abutting a bottom of the pressing sleeve 5. The stop shoulder 72 of the support shaft 7 has an annular shape and has a size greater than that of the upper end 70 of the support shaft 7.

The pressing sleeve 5 is made of a resilient material, such as a plastic material and the like. The pressing sleeve 5 has an outer diameter equal to a diameter of the support shaft 7 and has an inner diameter equal to a diameter of the upper end 70 of the support shaft 7 so that the pressing sleeve 5 is flush with the support shaft 7. The pressing sleeve 5 has a substantially cylindrical shape and has an inner wall provided with an inner flange 52 retained in the retaining groove 71 of the support shaft 7 and an outer wall provided with an outer flange 51.

The inner flange 52 of the pressing sleeve 5 extends radially and inwardly from the inner wall of the pressing sleeve 5. The inner flange 52 of the pressing sleeve 5 has an annular shape and has a convex cross-sectional profile. The inner flange 52 of the pressing sleeve 5 has a width slightly greater than that of the retaining groove 71 of the support shaft 7.

The outer flange 51 of the pressing sleeve 5 extends radially and outwardly from the outer wall of the pressing sleeve 5. The outer flange 51 of the pressing sleeve 5 has an annular shape and has a convex cross-sectional profile. The outer flange 51 of the pressing sleeve 5 aligns with the inner flange 52 of the pressing sleeve 5. The outer flange 51 of the pressing sleeve 5 has a size greater than that of the support shaft 7 so that the outer flange 51 of the pressing sleeve 5 protrudes outwardly from the support shaft 7.

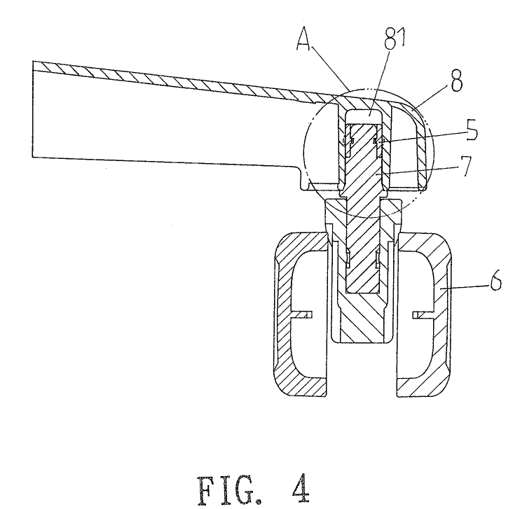

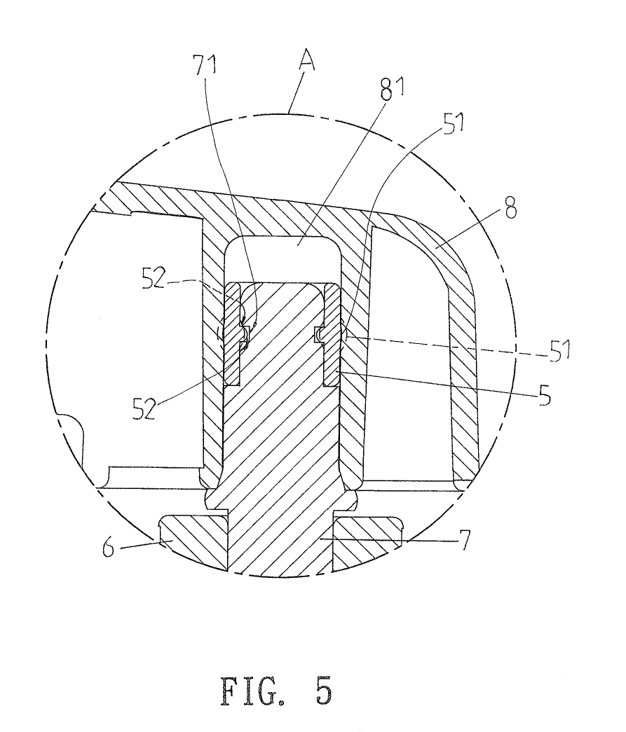

Referring to FIGS. 1-5, the castor assembly in accordance with the preferred embodiment of the present invention further comprises a leg 8 mounted on the support shaft 7 and the pressing sleeve 5, and a castor 6 rotatably mounted on a lower end of the support shaft 7. The leg 8 is made of metal and has an end portion provided with a receiving space 81 mounted on the support shaft 7 and pressing the pressing sleeve 5. The receiving space 81 of the leg 8 has a peripheral wall pressing the outer flange 51 of the pressing sleeve 5 so that the inner flange 52 and the outer flange 51 of the pressing sleeve 5 are pressed between the retaining groove 71 of the support shaft 7 and the receiving space 81 of the leg 8, and the pressing sleeve 5 is located between the upper end 70 of the support shaft 7 and the leg 8.

In assembly, when the support shaft 7 is inserted into the receiving space 81 of the leg 8, the outer flange 51 of the pressing sleeve 5 is pressed by the peripheral wall of the receiving space 81, so that the pressing sleeve 5 is pressed toward the upper end 70 of the support shaft 7, and the inner flange 52 of the pressing sleeve 5 is further extended into the retaining groove 71 of the support shaft 7. Thus, the pressing sleeve 5 is closely located between the support shaft 7 and the leg 8 so that the support shaft 7 is combined with the leg 8 closely and exactly by provision of the pressing sleeve 5 between the support shaft 7 and the leg 8. In such a manner, when the castor 6 is rolled, the support shaft 7 is combined with the leg 8 closely and completely by provision of the pressing sleeve 5 between the support shaft 7 and the leg 8 so that no gap is defined between the support shaft 7, the pressing sleeve 5 and the leg 8 to prevent from producing noise or vibration due to hit between the support shaft 7, the pressing sleeve 5 and the leg 8.

Accordingly, the support shaft 7 is combined with the leg 8 closely and completely by provision of the pressing sleeve 5 between the support shaft 7 and the leg 8 to prevent from defining a gap between the support shaft 7 and the leg 8 so that the support shaft 7 will not hit the leg 8 so as to prevent from producing noise or vibration during movement of the castor 6. In addition, the pressing sleeve 5 is made of a resilient plastic material so that the support shaft 7 is combined with the leg 8 closely and tightly. Further, the pressing sleeve 5 is made of a resilient plastic material to reduce the friction between the pressing sleeve 5 and the leg 8 so that the pressing sleeve 5 and the leg 8 will not produce a gap due to a long-term rubbing action so as to prevent from producing noise and to enhance the lifetime of the castor assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor assembly, comprising:
an upright support shaft:
a pressing sleeve mounted on an upper end of the support shaft;
wherein the upper end of the support shaft has a periphery provided with an annular retaining groove;
the pressing sleeve has an inner wall provided with an inner flange retained in the retaining groove of the support shaft and an outer wall provided with an outer flange.

2. The castor assembly of claim 1, wherein the inner flange of the pressing sleeve has a width slightly greater than that of the retaining groove of the support shaft.

3. The castor assembly of claim 1, wherein the inner flange of the pressing sleeve has a convex cross-sectional profile.

4. The castor assembly of claim 1, wherein the outer flange of the pressing sleeve has a convex cross-sectional profile.

5. The castor assembly of claim 1, wherein the outer flange of the pressing sleeve aligns with the inner flange of the pressing sleeve.

6. The castor assembly of claim 1, wherein the inner flange of the pressing sleeve has an annular shape.

7. The castor assembly of claim 1, wherein the outer flange of the pressing sleeve has an annular shape.

8. The castor assembly of claim 1, wherein
the pressing sleeve has an outer diameter equal to a diameter of the support shaft;
the pressing sleeve has an inner diameter equal to a diameter of the upper end of the support shaft;
the pressing sleeve is flush with the support shaft.

9. The castor assembly of claim 1, wherein the inner flange of the pressing sleeve extends radially and inwardly from the inner wall of the pressing sleeve.

10. The castor assembly of claim 1, wherein the outer flange of the pressing sleeve extends radially and outwardly from the outer wall of the pressing sleeve.

11. The castor assembly of claim 1, wherein
the outer flange of the pressing sleeve has a size greater than that of the support shaft;
the outer flange of the pressing sleeve protrudes outwardly from the support shaft.

12. The castor assembly of claim 1, wherein the upper end of the support shaft has a size smaller than that of the support shaft.

13. The castor assembly of claim 12, wherein the support shaft has a surface provided with a stop shoulder abutting a bottom of the pressing sleeve.

14. The castor assembly of claim 13, wherein the stop shoulder of the support shaft has an annular shape.

15. The castor assembly of claim 13, wherein the stop shoulder of the support shaft has a size greater than that of the upper end of the support shaft.

16. The castor assembly of claim 1, wherein the pressing sleeve has a substantially cylindrical shape.

17. The castor assembly of claim 1, wherein
the castor assembly further comprises a leg mounted on the support shaft and the pressing sleeve;
the leg has an end portion provided with a receiving space mounted on the support shaft and pressing the pressing sleeve;
the receiving space of the leg has a peripheral wall pressing the outer flange of the pressing sleeve.

18. The castor assembly of claim 1, wherein
the inner flange and the outer flange of the pressing sleeve are pressed between the retaining groove of the support shaft and the receiving space of the leg;
the pressing sleeve is located between the upper end of the support shaft and the leg.
